(19) United States
(12) Patent Application Publication
(10) Pub. No.: US 2018/0188736 A1
(43) Pub. Date: Jul. 5, 2018

(54) SYSTEM AND METHOD FOR VEHICLE LOCALIZATION ASSISTANCE USING SENSOR DATA

(71) Applicant: Faraday&Future Inc., Gardena, CA (US)

(72) Inventors: Yong-Dian Jian, Campbell, CA (US); Kai Ni, Sammamish, WA (US)

(21) Appl. No.: 15/679,019

(22) Filed: Aug. 16, 2017

Related U.S. Application Data
(60) Provisional application No. 62/375,862, filed on Aug. 16, 2016.

(51) Int. Cl. G05D 1/02; G05D 1/00; G01C 21/36; G01C 21/30

(52) U.S. Cl. CPC G05D 1/0231; G05D 1/0088; G05D 2201/0213; G01C 21/30; G05D 1/0274; G01C 21/3602

(57) ABSTRACT

Systems and methods relating to determining a position or orientation of a vehicle are disclosed. A landmark is identified using sensor data presented by one or more sensors included with the vehicle. The landmark is identified using map data relating to an approximate location of the vehicle in a world coordinate system. A position or orientation of the vehicle relative to the landmark is determined. A position or orientation of the landmark relative to the world coordinate system is determined. Using the determined position or orientation of the vehicle relative to the landmark and the determined position or orientation of the landmark relative to the world coordinate system, a position or orientation of the vehicle relative to the world coordinate system is determined.

### CROSS-REFERENCE TO RELATED APPLICATIONS

This application claims the benefit of U.S. Provisional Application No. 62/375,862, filed Aug. 16, 2016, the entirety of which is hereby incorporated by reference.

### FIELD OF THE DISCLOSURE

The present invention relates to assisting with the determination of a position or orientation of a vehicle, including using sensor data to improve the determining of a position or orientation of a vehicle.

### BACKGROUND OF THE DISCLOSURE

Location-sensitive features of modern vehicles can enhance a vehicle operator's experience by providing information or making decisions that take into account the vehicle's position and orientation in the world. For example, onboard vehicle navigation systems can use a vehicle's current position to compute the shortest route to a target destination, or to suggest nearby products or services; and autonomous vehicles can use the vehicle's location and orientation to automate driving operations such as steering and parking. (As used herein, an autonomous vehicle can be one in which one or more driving operations traditionally performed by a human driver may be performed or enhanced by a computer system.) Location-sensitive features are only as accurate, useful, and reliable as the location data on which they rely. Existing location systems such as the Global Positioning System (GPS) and Global Navigation Satellite System (GNSS) are in wide use, but the limited precision of data received from those systems may limit the development of vehicle features that depend on those systems. Further, existing location systems are often dependent on satellite signals of sufficient strength, which may be unavailable or intermittently available in some situations. It is thus desirable to provide vehicles with more precise location data to improve the accuracy and usability of existing location-sensitive features, and to enable new such features. Further, it is desirable to provide such data while making use of existing location systems, such as GPS, in which there has been substantial investment and on which many existing systems currently rely. It is an intent of the present invention to augment existing vehicle location systems such as GPS using the systems and methods disclosed herein. It is a further intent of the present invention to enhance the behavior of autonomous driving systems with precise localization information.

### SUMMARY OF THE DISCLOSURE

An example of the present invention is directed to using sensor data representing information about a vehicle's surroundings, and/or one or more landmarks in the vicinity of the vehicle that are identified from the data, to determine a position or orientation of the vehicle relative to the one or more landmarks. In accordance with another aspect of the example, one or more of the landmarks can be identified from map data that relates landmarks to a world coordinate system, for example by associating point clouds of structures or terrain with satellite (e.g., GPS) coordinates. Using a position or orientation of the vehicle relative to one or more landmarks, and a position or orientation of the one or more landmarks relative to the world coordinate system, a position or orientation of the vehicle relative to the world coordinate system can be determined. The precision of such position or orientation potentially may exceed the precision or reliability of a position or orientation obtained from a single location system, such as GPS, alone.

### BRIEF DESCRIPTION OF THE DRAWINGS

FIG. 1 illustrates a system block diagram of a vehicle control system according to examples of the disclosure.

FIG. 2 illustrates an example scenario in which an approximate location of a vehicle in a world coordinate system is identified, for example using GPS.

FIG. 3 illustrates an example scenario in which a vehicle includes one or more sensors, for example a camera.

FIG. 4A illustrates an example scenario in which a vehicle is in operation at a location whose precise location in a world coordinate system is unknown.

FIGS. 4B and 4C illustrate an example scenario in which sensor data is presented by a camera included in a vehicle, and one or more landmarks are identified from the sensor data.

FIGS. 5A and 5B illustrate an example scenario in which map data relating to an approximate location of a vehicle in a world coordinate system is presented, and one or more landmarks are identified from the map data.

FIGS. 6A and 6B illustrate an example scenario in which common landmarks are identified from one or more landmarks identified from sensor data presented by a camera included in a vehicle and one or more landmarks identified from map data relating to an approximate location of a vehicle in a world coordinate system.

FIG. 6C illustrates an example scenario in which a position and orientation of a vehicle relative to one or more common landmarks are determined from sensor data presented by one or more sensors included in the vehicle.

FIG. 6D illustrates an example scenario in which a position and orientation of one or more common landmarks relative to a world coordinate system are determined from map data relating to an approximate location of a vehicle in the world coordinate system.

FIG. 7 illustrates an example scenario in which a precise location of a vehicle in a world coordinate system is identified using the position and orientation of the vehicle relative to one or more landmarks and the position and orientation of the one or more landmarks relative to the world coordinate system.

FIG. 8 illustrates an exemplary system block diagram depicting the determination of a location of a vehicle in a world coordinate system.

### DETAILED DESCRIPTION

In the following description of examples, reference is made to the accompanying drawings which form a part hereof, and in which it is shown by way of illustration specific examples that can be practiced. It is to be understood that other examples can be used and structural changes can be made without departing from the scope of the disclosed examples.

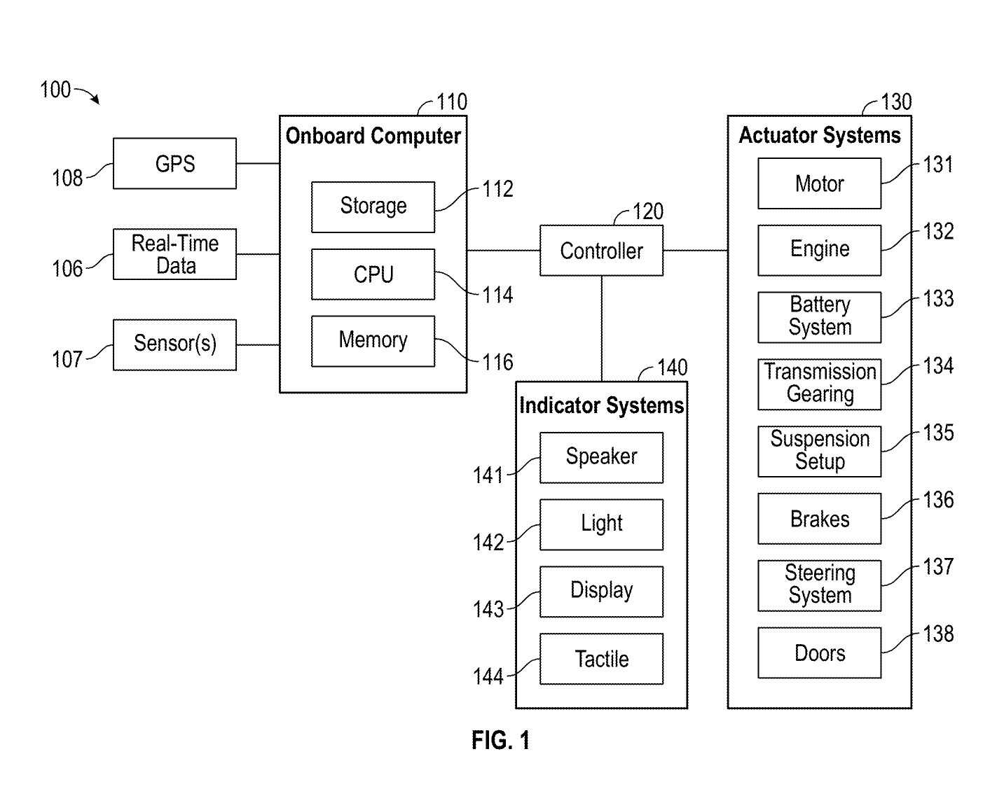

FIG. 1 illustrates an exemplary system block diagram of vehicle control system 100 according to examples of the disclosure. System 100 can be incorporated into a vehicle, such as a consumer automobile. Other example vehicles that may incorporate the system 100 include, without limitation, airplanes, boats, or industrial automobiles. Vehicle control system 100 can include one or more receivers 106 for real-time data, such as the current locations of nearby objects or weather patterns. Vehicle control system 100 can also include one or more sensors 107 (e.g., microphone, optical camera, radar, ultrasonic, LIDAR, etc.) capable of detecting various characteristics of the vehicle's surroundings, such as the position and orientation of landmarks relative to the vehicle or a sensor; and a satellite (e.g., Global Positioning System (GPS)) receiver 108 capable of determining an approximate position or orientation of the vehicle relative to a world coordinate system. Vehicle control system 100 can include an onboard computer 110 that is coupled to the receivers 106, sensors 107 and satellite (e.g., GPS) receiver 108, and that is capable of receiving data from the receivers 106, sensors 107 and satellite (e.g., GPS) receiver 108. The onboard computer 110 can include storage 112, memory 116, and a processor 114. Processor 114 can perform any of the methods described herein. Additionally, storage 112 and/or memory 116 can store data and instructions for performing any of the methods described herein. Storage 112 and/or memory 116 can be any non-transitory computer readable storage medium, such as a solid-state drive or a hard disk drive, among other possibilities. The vehicle control system 100 can also include a controller 120 capable of controlling one or more aspects of vehicle operation, such as indicator systems 140 and actuator systems 130.

In some examples, the vehicle control system 100 can be connected or operatively coupled to (e.g., via controller 120) one or more actuator systems 130 in the vehicle and one or more indicator systems 140 in the vehicle. The one or more actuator systems 130 can include, but are not limited to, a motor 131 or engine 132, battery system 133, transmission gearing 134, suspension setup 135, brakes 136, steering system 137 and door system 138. The vehicle control system 100 can control, via controller 120, one or more of these actuator systems 130 during vehicle operation; for example, to open or close one or more of the doors of the vehicle using the door actuator system 138, or to control the vehicle during autonomous or semi-autonomous driving or parking operations, using the motor 131 or engine 132, battery system 133, transmission gearing 134, suspension setup 135, brakes 136 and/or steering system 137, etc. The one or more indicator systems 140 can include, but are not limited to, one or more speakers 141 in the vehicle (e.g., as part of an entertainment system in the vehicle), one or more lights 142 in the vehicle, one or more displays 143 in the vehicle (e.g., as part of a control or entertainment system in the vehicle) and one or more tactile actuators 144 in the vehicle (e.g., as part of a steering wheel or seat in the vehicle). The vehicle control system 100 can control, via controller 120, one or more of these indicator systems 140 to provide indications to a driver of the vehicle of one or more characteristics of the vehicle's surroundings that are determined using the onboard computer 110, such as a position or orientation of the vehicle relative to a world coordinate system.

It can be beneficial to use sensors 107 to determine a position or orientation of a vehicle relative to a world coordinate system. Examples of the disclosure are directed to using one or more sensors attached to a vehicle in conjunction with a location system, such as a GPS receiver, to identify such a position or orientation with a higher degree of precision than can be achieved using a GPS receiver alone. The disclosure is not limited to any particular type of world coordinate system (e.g. geodetic, earth-centered earth-fixed (ECEF)); nor is the disclosure limited to any particular type of location system (e.g. GPS), or even to the use of a location system at all; nor is the disclosure limited to any particular type of representation of a position or an orientation.

Examples of the disclosure are directed to using map data to determine a position or orientation of a vehicle relative to a world coordinate system. The disclosure is not limited to any particular type or format of map data; nor is the disclosure limited to map data stored or received in any particular manner. For example, the map data could be stored in local memory, streamed via the Internet, received via broadcast, etc.

Examples of the disclosure are directed to identifying landmarks. As used herein, a landmark is any point or region for which a position or orientation can be expressed as coordinates in a coordinate system. For example, a landmark could be a tree, a lamp post, a pedestrian, a building, a street sign, a road intersection, a city, a point on a two-dimensional map, a grain of sand, or many other things.

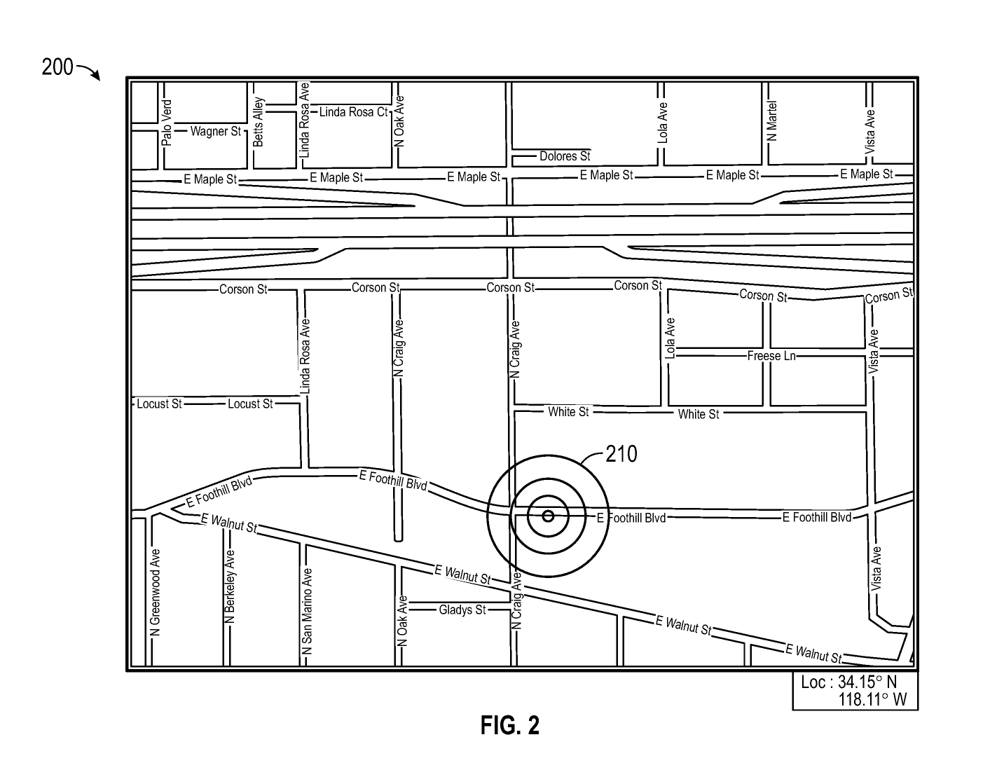

FIG. 2 shows an example estimated position of a vehicle in a world coordinate system estimated using GPS and overlaid on a two-dimensional map 200. The limited accuracy of location systems such as GPS is shown by position indicator 210, which reflects location accuracy to only two decimal places. Typical civilian GPS receivers, as an example, may be accurate only to a distance of about 10 to 15 meters. Furthermore, GPS receivers are dependent on the availability of GPS satellite signals, which is not guaranteed. It should be noted that where GPS is referenced in this disclosure herein, other similar satellite systems may be substituted. Additionally, some examples may use other systems or techniques for estimating a vehicle's position, for example, triangulation using cellular data signals or Wi-Fi signals.

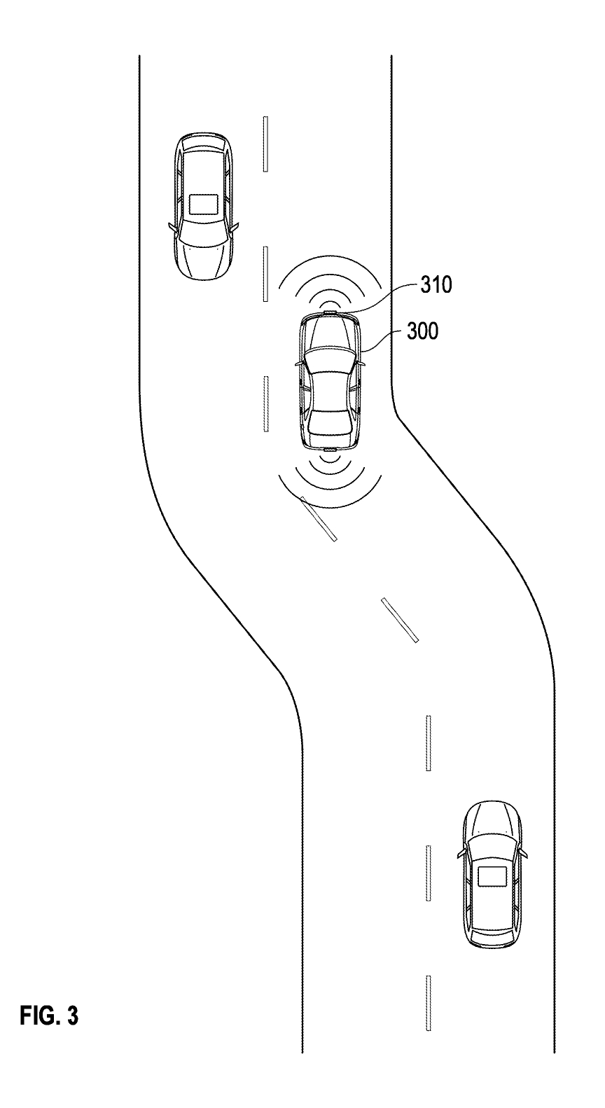

FIG. 3 illustrates exemplary vehicle 300, according to examples of the disclosure. Vehicle 300 includes one or more sensors 310 for providing information about one or more characteristics of the vehicle's surroundings, such as acoustic signals in the vehicle's surroundings; optical signals in the vehicle's surroundings; the locations and/or movements of objects or other vehicles in the vehicle's surroundings; etc. Sensors 310 can include microphones, optical cameras, ultrasonic sensors, laser sensors, radar sensors, LIDAR sensors, or any other sensors that can be used (alone or in combination) to detect one or more characteristics of the vehicle's surroundings. In the example scenario shown in FIG. 3, vehicle 300 can process data, using signal processing techniques known in the art, from one or more of sensors 310 to make a determination about the presence of landmarks in the vicinity of the vehicle, and to make a determination about a position or orientation of such landmarks.

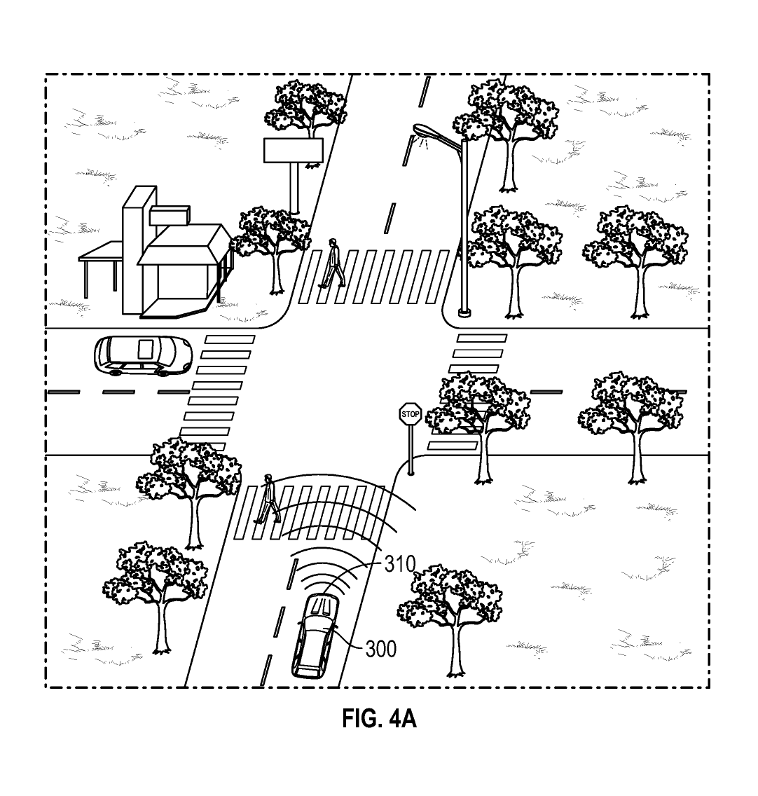

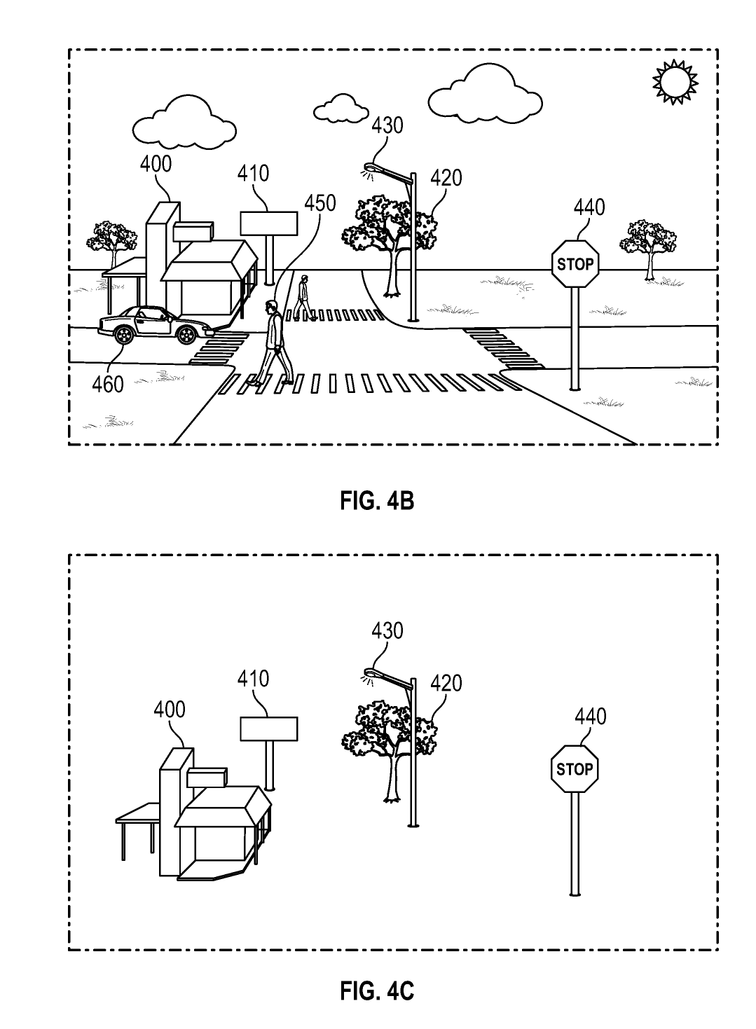

FIG. 4A illustrates a top-down view of exemplary vehicle 300, according to examples of the disclosure, whose precise position or orientation in a world coordinate system are unknown. Exemplary sensors 310, which are included with vehicle 300, present data from which one or more landmarks may be identified. FIG. 4A illustrates an example scenario in which sensors 310 include a camera mounted to vehicle 300 and facing forward relative to vehicle 300.

FIG. 4B illustrates example sensor data presented by the example camera included in example sensors 310 in FIG. 4A and mounted to vehicle 300 in FIG. 4A. Multiple example landmarks in the vicinity of vehicle 300 can potentially be identified using the example sensor data, from example sensors 310, for example: restaurant 400, advertisement 410, tree 420, lamp post 430, stop sign 440, pedestrian 450, and second vehicle 460. In some examples, LIDAR data can determine words on signs, road signals, pedestrians, and other data.

FIG. 4C illustrates a scenario in which example landmarks have been identified using sensor data from sensors 310: restaurant 400, advertisement 410, tree 420, lamp post 430, and stop sign 440. In some examples, the landmarks actually identified from the sensor data are a subset of the landmarks that can potentially be identified from the sensor data. In some examples, landmarks identified from the sensor data are identified based on their expected usefulness in determining a position or orientation of a vehicle with respect to a world coordinate system. A landmark is more useful than another if it is more significant in determining a vehicle's position and/or orientation. Factors that affect how useful a landmark is include how permanent the landmark is; how easily the landmark can be identified from sensor data and/or map data; how available the landmark is in commercially available map data; and how reliably the landmark can be identified from sensor data and/or map data. For example, fixed and semi-permanent human-built structures such as lamp posts, street signs, and buildings may be highly useful landmarks, because their positions, orientations, and outward appearances change infrequently, if at all. Additionally, such structures may contain relatively simple edges and surfaces that simplify identifying these landmarks from sensor data and/or map data. Such objects are also likely to be present in commercially available map data. In contrast, mobile objects such as cars and pedestrians are less useful as landmarks in determining a position or orientation of a vehicle with respect to a world coordinate system, because the positions and orientations of these mobile objects change continuously, making it difficult to identify such objects from sensor data and/or map data. Such objects are also unlikely to be present in commercially available map data. Natural landmarks such as trees are examples of landmarks that may be of intermediate usefulness: for example, their general positions and orientations may remain constant over time, contributing to their usefulness; but their outward appearances may change as, for example, deciduous trees shed foliage with the seasons. Moreover, natural landmarks such as trees may contain many complex surfaces. These factors may make it difficult to reliably identify natural landmarks from sensor data and/or map data, and are examples of factors that limit the usefulness of natural landmarks.

The usefulness of a landmark can be quantified according to how significant that landmark is in determining a vehicle's position and/or orientation. In some examples, landmarks may be identified if they are likely to meet or exceed a threshold value of usefulness, and rejected otherwise. In some examples, a landmark may influence determining a position or orientation of a vehicle with respect to a world coordinate system based on its expected usefulness.

Various techniques for identifying landmarks from sensor data are known to those skilled in the art. Such techniques vary based on the number and type of sensors employed. For example, where the sensor data includes an image presented by a camera, edge detection algorithms known in the art can be applied to the image to identify the shapes and boundaries of landmarks.

In some examples, landmark identification may be improved by utilizing sensor data from multiple sensors instead of a single sensor. For example, using techniques known in the art, LIDAR data and camera data can be combined to identify nearby objects with more accuracy than is possible with either LIDAR data or camera data acting alone.

Landmarks may be classified by their expected usefulness, as in some examples, using techniques known to those skilled in the art. For example, mobile objects such as pedestrians, which carry a low degree of expected usefulness, can be identified by comparing sensor data from multiple points in time to determine whether the landmarks have moved over time.

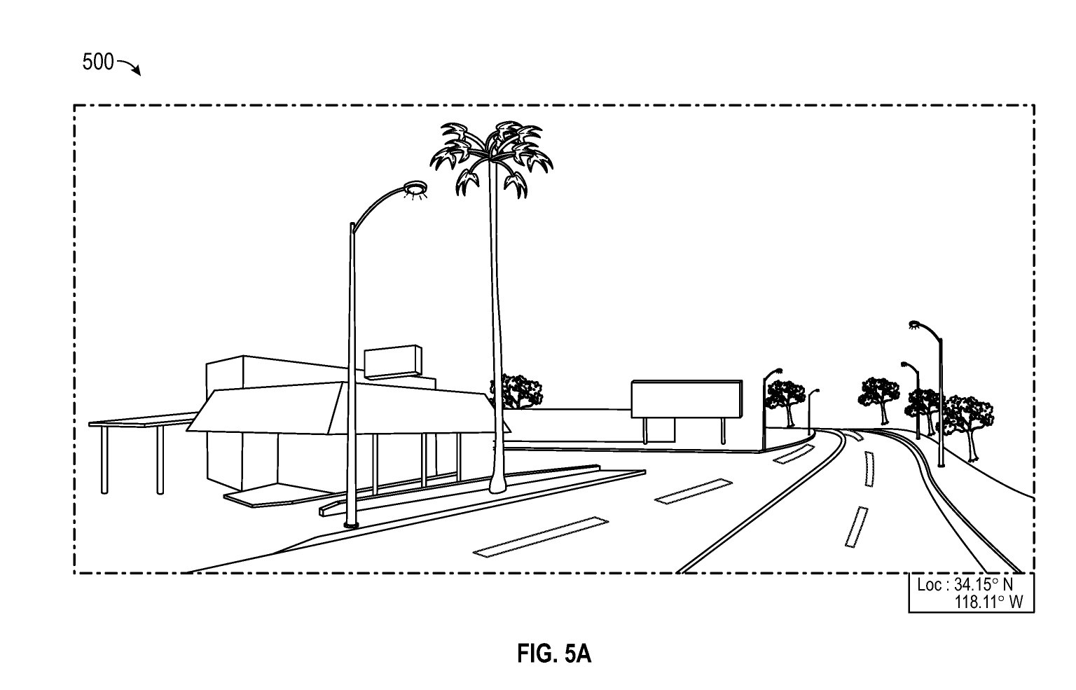

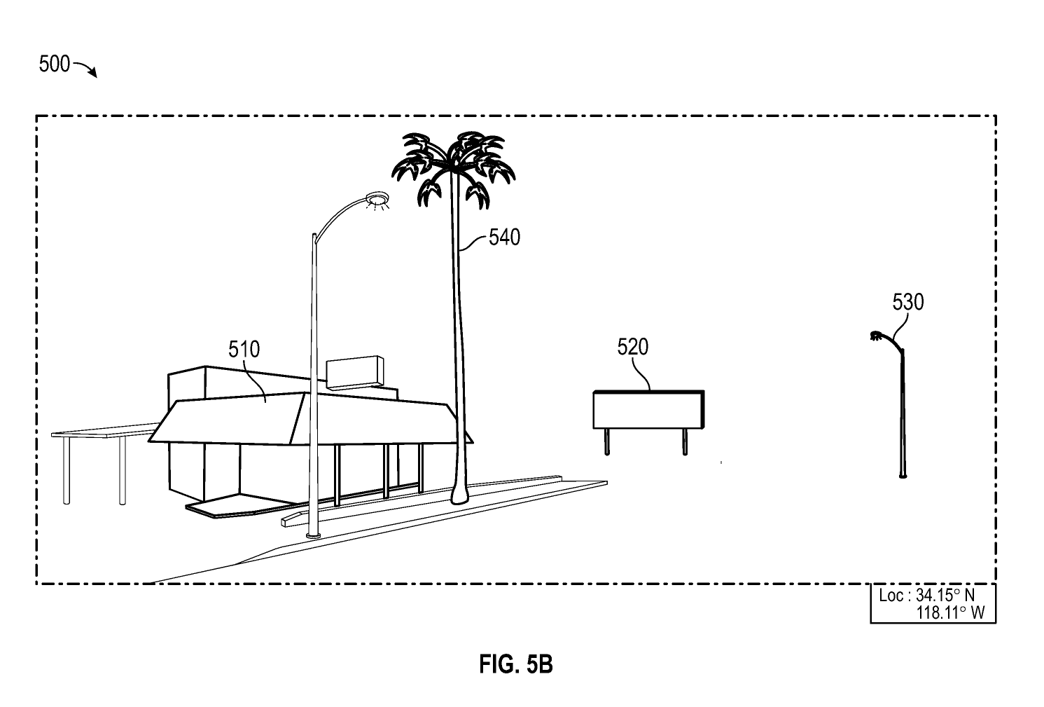

FIG. 5A shows example map data 500 relating to a vehicle's estimated position in a world coordinate system. In some examples, map data is commercially available map data, such as illustrated in FIG. 5A and sold by vendors such as TomTom, HERE, and Sanborn. In some examples, map data is provided by the vehicle, the vehicle's manufacturer, and/or third parties. Map data comprises data relating landmarks such as roads, structures, and signs to coordinates in a world coordinate system. The positions and orientations of these landmarks relative to the world coordinate system can be determined using the map data using techniques known in the art. In the example depicted in FIG. 5A, roads and various other landmarks in the vicinity of the vehicle's estimated position are reflected in the map data.

FIG. 5B shows example landmarks identified using example map data 500: restaurant 510, advertisement 520, lamp post 530, and palm tree 540. As disclosed above, techniques are known in the art for identifying some landmarks instead of others based on the expected usefulness of those landmarks.

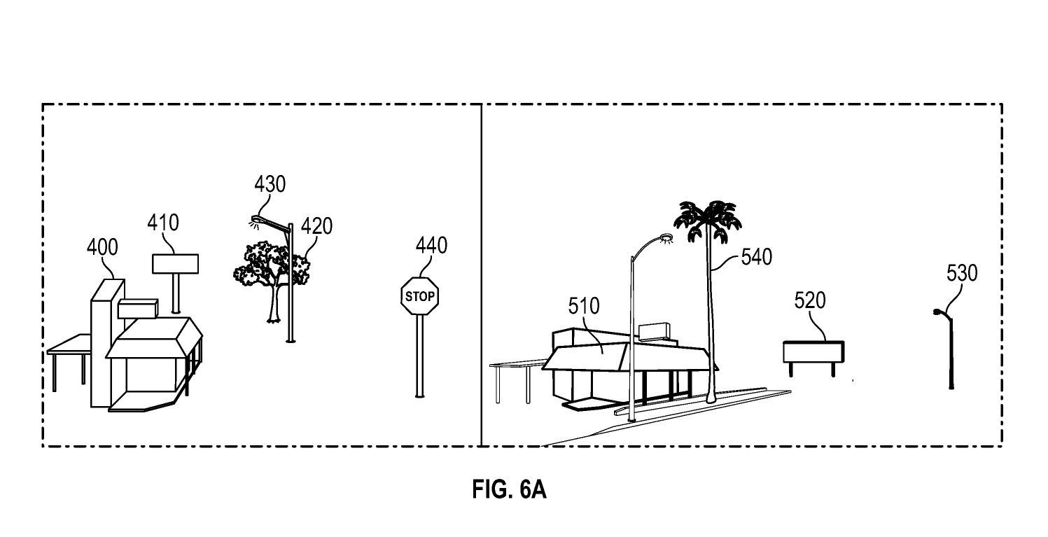

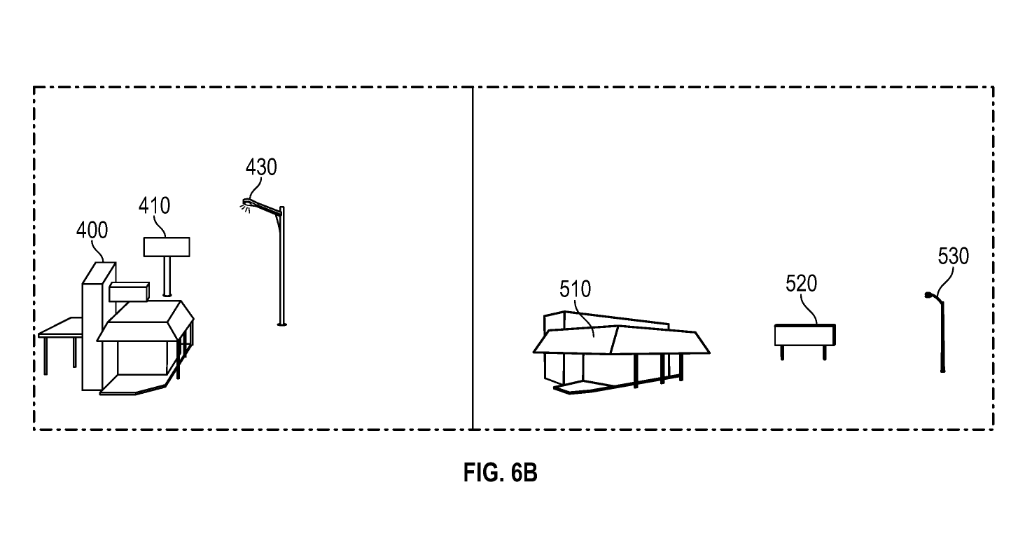

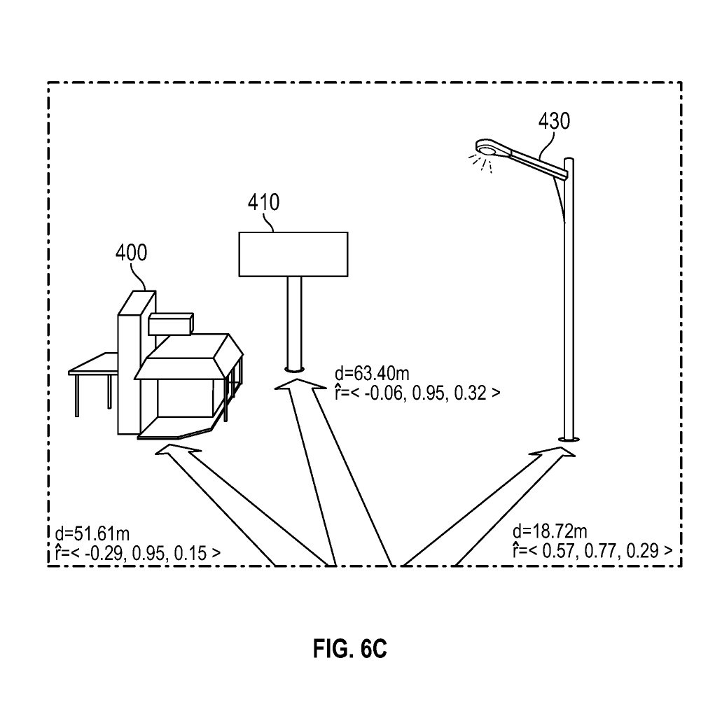

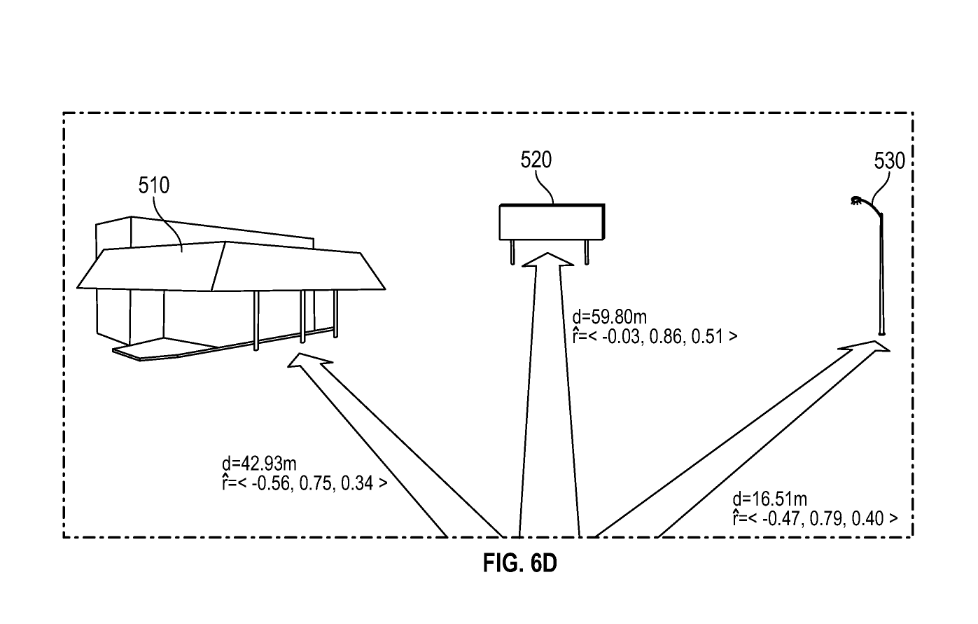

In FIGS. 6A-6B, landmarks identified from sensor data (“sensor data landmarks”) are compared with landmarks identified from map data (“map data landmarks”) to identify the common landmarks identified from both sensor data and map data. FIG. 6A shows example sensor data landmarks 400, 410, 420, 430, and 440, identified from sensor data for example as illustrated in FIG. 4C, alongside example map data landmarks 510, 520, 530, and 540, identified from map data for example as illustrated in FIG. 5B. In some embodiments, sensors on a vehicle may need to be calibrated and/or identify landmarks when a vehicle is not at its expected orientation (e.g., if a vehicle tilts forward and the horizon changes, or if the vehicle tilts to one side while turning). The two sets of example landmarks shown in the figures are compared using techniques known in the art to identify which sensor data landmarks correspond to which map data landmarks. For example, object recognition algorithms, known in the art, can be applied to the sensor data and the map data to identify corresponding landmarks. FIG. 6B shows the example landmarks that are common to both sets: restaurant 400 and 510; advertisement 410 and 520; and lamp post 430 and 530. In some examples, the remaining landmarks, which do not appear in both sets of landmarks, can be discarded.

FIG. 6C shows the example sensor data landmarks 400, 410, and 430 that are also map data landmarks. For each landmark in the example scenario depicted in FIG. 6C, using the sensor data, a vector, comprising a magnitude (distance) and a unit vector, representing the position of the landmark relative to the vehicle is determined. Techniques for determining such a vector from sensor data are known in the art, and the specific techniques will depend on the number and type of sensors employed. For example, a LIDAR sensor can determine the distance from the LIDAR sensor to a landmark that intersects the LIDAR sensor's beam axis; and in examples where the position and orientation of the LIDAR beam are known with respect to the vehicle's position and orientation, the unit vector from the vehicle to the landmark can be determined by transforming the landmark's coordinates into vehicle-space via known matrix algebra techniques. As another example, a landmark's position and orientation can be determined from two sets of camera sensor data—taken, for example, from two cameras mounted to one vehicle, or from a single camera at two different points in time—via triangulation techniques known in the art. Regardless of the specific technique used, the result is to determine the position and/or orientation of a vehicle with respect to a map data landmark. For example, in FIG. 6C, the position of a vehicle with respect to landmark 430 (lamp post), which corresponds to map data landmark 530, is described by a vector with magnitude 18.72 meters, in the direction of unit vector <0.57, 0.77, 0.29>. It should be noted that determining the position and/or orientation of a landmark with respect to a vehicle also determines the position and/or orientation of the vehicle with respect to that landmark.

FIG. 6D shows the example map data landmarks 510, 520, and 530 that are also example sensor data landmarks. For each landmark in the example scenario depicted in FIG. 6D, using the map data, a vector, comprising a magnitude (distance) and a unit vector, representing the position of the landmark relative to map data's world coordinate system is determined using techniques known in the art. For example, where the map data represents landmarks as point clouds in a world coordinate system, the position of the landmarks can be computed directly from the coordinates of the point clouds. In some examples, the position and/or orientation of landmarks is precomputed and retrievable from the map data. The result is to determine the position and/or orientation of a map data landmark with respect to the world coordinate system. For example, in FIG. 6D, the position of map data landmark 530 (lamp post), which corresponds to sensor data landmark 330, is described by a vector with magnitude 16.51 meters, in the direction of unit vector <0.47, 0.79, 0.40>. It should be noted that determining the position and/or orientation of a landmark with respect to a location in a world coordinate system also determines the position and/or orientation of the location with respect to that landmark.

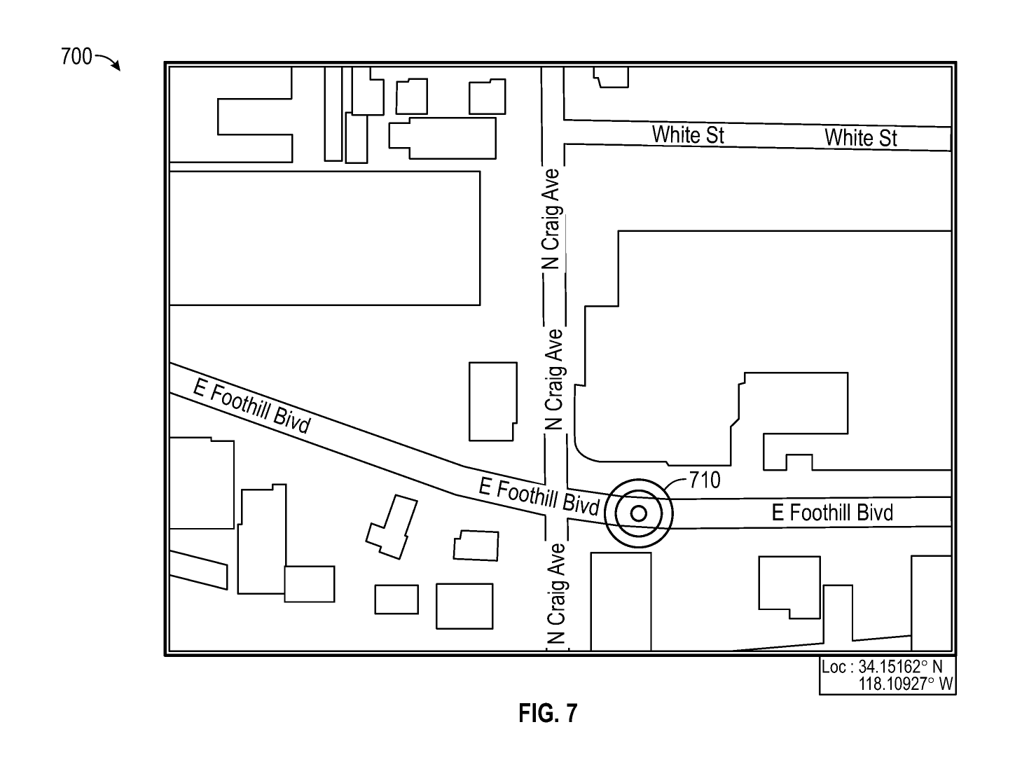

With knowledge of the position and/or orientation of a vehicle with respect to a landmark identified from both sensor data and map data, and knowledge of the landmark with respect to a world coordinate system, the position and/or orientation of the vehicle with respect to the world coordinate system is determined using techniques known in the art. As an example, if a position and orientation of the vehicle with respect to the landmark is represented as a matrix A, and a position and orientation of the landmark with respect to the world coordinate system is represented as a matrix B, then a matrix C representing a position and orientation of the vehicle with respect to the world coordinate system can be computed from matrix A and matrix B using standard matrix algebra.

Where the sensor data and map data is of sufficiently high accuracy and resolution, the determined position and/or orientation of the vehicle with respect to the world coordinate system may be more accurate than what can be estimated using GPS or another location system. FIG. 7 shows a location of a vehicle determined according to examples of the disclosure, where the location is known to a greater degree of precision than, for example, the example location estimated by GPS in FIG. 2.

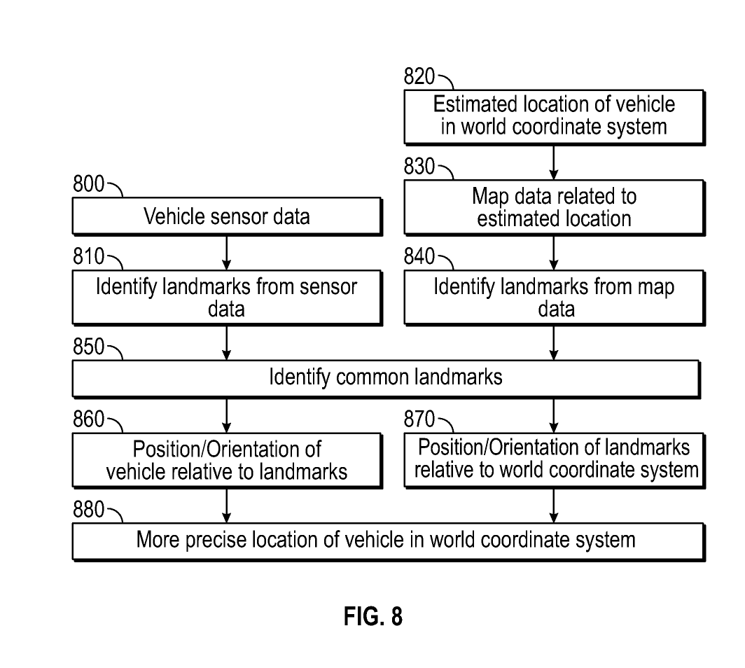

FIG. 8 shows an example process that incorporates several features discussed above. Vehicle sensor data presented at stage 800 is used to identify landmarks from that sensor data at stage 810. At stage 820, an approximate location of the vehicle in a world coordinate system is presented, such as by a GPS receiver. At stage 830, map data related to this approximate location is presented. At stage 840, landmarks are identified from the map data. In the example process illustrated in FIG. 8, stages 820, 830, and 840 occur in parallel with stages 800 and 810. However, in other examples, stages 820, 830, and 840 occur in series with stages 800 and 810, occurring either before or after stages 800 and 810. At stage 850, the landmarks identified in stage 810 and stage 840 are compared, with the goal of identifying the common landmarks that were identified in both stage 810 and stage 840. At stage 860, the position and/or orientation of the vehicle relative to one or more common landmarks is determined from the sensor data. At stage 870, the position and/or orientation of the vehicle relative to one or more corresponding landmarks is determined from the map data. In the example process illustrated in FIG. 8, stages 860 and 870 occur in parallel; however, in other examples, stages 860 and 870 occur in series. At stage 880, a precise position/orientation of the vehicle in the world coordinate system is determined using the position/orientation determined at stage 860 and the position/orientation determined at stage 870.

Further improvements are contemplated by the disclosure. In some examples, computational efficiencies can be achieved by storing computed values, such as position and/or orientation values for significant landmarks, in a shared repository. Other vehicles can then retrieve these values from the shared repository, using techniques known in the art, instead of recomputing them. For frequently traveled bridges and roadways, for example, position and orientation values could be pre-computed and stored in a shared repository for later retrieval by vehicles using those bridges and roadways. Additionally, data stored in a shared repository could be reviewed for analytic purposes.

Other examples use sensor data to supplement or correct map data, which may become out of date and inaccurate as changes are made to roads and other landmarks. As one example, if existing map data relating to a road sign indicates the road is open, and new sensor data relating to the road sign indicates the road is now closed, the sensor data indicates the map data is out of date; the map data in some examples is updated accordingly using the sensor data.

Other examples utilize machine learning techniques, known in the art, to enhance determining a position or orientation. In some examples, values including positions, orientations, and estimated locations are used to train a neural network, the neural network to be used according to techniques known in the art to improve the speed and accuracy of future position and orientation determinations.

In some examples in which a vehicle whose position or orientation is to be determined is a fully autonomous vehicle, the determined position or orientation is used by the vehicle to execute a driving operation. For example, a fully autonomous vehicle could automate parking behaviors or driving maneuvers in close quarters using a position or orientation determined with a high degree of precision.

In some examples in which the vehicle is not a fully autonomous vehicle, the determined position or orientation is used to enhance the execution of manual driving operations—for example, by automatically enabling anti-lock braking systems or traction control systems when the vehicle traverses locations with low-friction road surfaces.

Some examples of the disclosure are directed to a method of determining a position or orientation of a vehicle, the method comprising: identifying a landmark using sensor data presented by one or more sensors included with the vehicle; identifying the landmark using map data relating to an approximate location of the vehicle in a world coordinate system; determining a position or orientation of the vehicle relative to the landmark; determining a position or orientation of the landmark relative to the world coordinate system; and determining, using the determined position or orientation of the vehicle relative to the landmark and the determined position or orientation of the landmark relative to the world coordinate system, a position or orientation of the vehicle relative to the world coordinate system. Additionally or alternatively to one or more of the examples disclosed above, in some examples, the method further comprises the step of storing a position or orientation in a shared repository. Additionally or alternatively to one or more of the examples disclosed above, in some examples, the method further comprises the step of retrieving a position or orientation from a shared repository. Additionally or alternatively to one or more of the examples disclosed above, in some examples, the map data comprises one or more values retrieved from a shared repository. Additionally or alternatively to one or more of the examples disclosed above, in some examples, a position or orientation is determined using a neural network. Additionally or alternatively to one or more of the examples disclosed above, in some examples, the method further comprises determining a usefulness of a landmark. Additionally or alternatively to one or more of the examples disclosed above, in some examples, the step of determining, using the determined position or orientation of the vehicle relative to the landmark and the determined position or orientation of the landmark relative to the world coordinate system, a position or orientation of the vehicle relative to the world coordinate system further comprises using a determined usefulness of a landmark. Additionally or alternatively to one or more of the examples disclosed above, in some examples, the method further comprises the step of updating the map data using the sensor data. Additionally or alternatively to one or more of the examples disclosed above, in some examples in which the vehicle is an autonomous vehicle, the method further comprises the step of executing a driving operation using the determined position or orientation of the vehicle relative to the world coordinate system.

Some examples of the disclosure are directed to a system comprising: one or more sensors included with a vehicle, the one or more sensors configured to present sensor data; one or more processors coupled to the one or more sensors; and a memory including instructions, which when executed by the one or more processors, cause the one or more processors to perform a method comprising: identifying a landmark using the sensor data; identifying the landmark using map data relating to an approximate location of the vehicle in a world coordinate system; determining a position or orientation of the vehicle relative to the landmark; determining a position or orientation of the landmark relative to the world coordinate system; and determining, using the determined position or orientation of the vehicle relative to the landmark and the determined position or orientation of the landmark relative to the world coordinate system, a position or orientation of the vehicle relative to the world coordinate system.

Some examples of the disclosure are directed to a non-transitory machine-readable storage medium containing program instructions executable by a computer, the program instructions enabling the computer to perform: identifying a landmark using sensor data presented by one or more sensors included with a vehicle; identifying the landmark using map data relating to an approximate location of the vehicle in a world coordinate system; determining a position or orientation of the vehicle relative to the landmark; determining a position or orientation of the landmark relative to the world coordinate system; and determining, using the determined position or orientation of the vehicle relative to the landmark and the determined position or orientation of the landmark relative to the world coordinate system, a position or orientation of the vehicle relative to the world coordinate system.

Although examples of this disclosure have been fully described with reference to the accompanying drawings, it is to be noted that various changes and modifications will become apparent to those skilled in the art. Such changes and modifications are to be understood as being included within the scope of examples of this disclosure as defined by the appended claims.

1. A method of determining a position or orientation of a vehicle, the method comprising:
identifying a landmark using sensor data presented by one or more sensors included with the vehicle;
identifying the landmark using map data relating to an approximate location of the vehicle in a world coordinate system;
determining a position or orientation of the vehicle relative to the landmark;
determining a position or orientation of the landmark relative to the world coordinate system; and
determining, using the determined position or orientation of the vehicle relative to the landmark and the determined position or orientation of the landmark relative to the world coordinate system, a position or orientation of the vehicle relative to the world coordinate system.

2. The method of claim 1, further comprising the step of storing a position or orientation in a shared repository.

3. The method of claim 2, further comprising the step of retrieving a position or orientation from a shared repository.

4. The method of claim 1, wherein the map data comprises one or more values retrieved from a shared repository.

5. The method of claim 1, wherein a position or orientation is determined using a neural network.

6. The method of claim 1, further comprising the step of determining a usefulness of a landmark.

7. The method of claim 6, wherein the step of determining, using the determined position or orientation of the vehicle relative to the landmark and the determined position or orientation of the landmark relative to the world coordinate system, a position or orientation of the vehicle relative to the world coordinate system further comprises using a determined usefulness of a landmark.

8. The method of claim 1, further comprising the step of updating the map data using the sensor data.

9. The method of claim 1 wherein the vehicle is an autonomous vehicle, and further comprising the step of executing a driving operation using the determined position or orientation of the vehicle relative to the world coordinate system.

10. A system comprising:
one or more sensors included with a vehicle, the one or more sensors configured to present sensor data;
one or more processors coupled to the one or more sensors; and
a memory including instructions, which when executed by the one or more processors, cause the one or more processors to perform a method comprising:
identifying a landmark using the sensor data;
identifying the landmark using map data relating to an approximate location of the vehicle in a world coordinate system;
determining a position or orientation of the vehicle relative to the landmark;
determining a position or orientation of the landmark relative to the world coordinate system; and
determining, using the determined position or orientation of the vehicle relative to the landmark and the determined position or orientation of the landmark relative to the world coordinate system, a position or orientation of the vehicle relative to the world coordinate system.

11. A non-transitory machine-readable storage medium containing program instructions executable by a computer, the program instructions enabling the computer to perform:
identifying a landmark using sensor data presented by one or more sensors included with a vehicle;
identifying the landmark using map data relating to an approximate location of the vehicle in a world coordinate system;
determining a position or orientation of the vehicle relative to the landmark;
determining a position or orientation of the landmark relative to the world coordinate system; and
determining, using the determined position or orientation of the vehicle relative to the landmark and the determined position or orientation of the landmark relative to the world coordinate system, a position or orientation of the vehicle relative to the world coordinate system.
